(19) United States
(12) Patent Application Publication
(10) Pub. No.: US 2018/0150405 A1
(43) Pub. Date: May 31, 2018

(54) DATA TYPE MANAGEMENT

(71) Applicant: Hewlett Packard Enterprise Development LP, Houston, TX (US)

(72) Inventors: Patrick Goldsack, Bristol (GB); Brian Quentin Monahan, Bristol (GB); James Salter, Bristol (GB); Adrian John Baldwin, Bristol (GB)

(21) Appl. No.: 15/577,846

(22) PCT Filed: Dec. 18, 2015
(86) PCT No.: PCT/US2015/066758

§ 371 Date: Nov. 29, 2017

(51) Int. Cl. G06F 12/1018; G06F 3/06

(52) U.S. Cl. CPC G06F 12/1018; G06F 3/065; G06F 2212/401; G06F 3/0679; G06F 3/0619; G06F 3/0649

(57) ABSTRACT

In one example in accordance with the present disclosure, a method for data type management may include adding a first data to a first data set. The first data set may belong to a plurality of data sets stored in a memory and each data set in the plurality may correspond to a type table defining data types in the corresponding data set. The method may further include determining that a first data type of the first data is not in a first type table corresponding to the first data set and generating an identifier corresponding to the first data type. The identifier may identify uses of the first data type within each data set in the plurality and may be a standardized value that is used by each data set in the plurality. The method may also include inserting the identifier into the first type table.

### BACKGROUND

Data processing includes generating data, storing data in memories and accessing stored data by a user or by an application. Accessing data may relate to reading data or modifying data. Various kinds of data may be used in data processing, and the kind of data is identified by a data type.

### BRIEF DESCRIPTION OF THE DRAWINGS

The following detailed description references the drawings, wherein:

FIG. 1 is a block diagram of an example system for data type management;

FIG. 2 is a flowchart of an example method for data type management;

FIG. 3 is a flowchart of an example method for determining compatibility between data types;

FIG. 4 is a block diagram of an example system for data type management; and

FIG. 5 is a block diagram of an example system for data type management.

### DETAILED DESCRIPTION

Programs (and the data stored as a result of the execution of those programs) may have different lifecycles or lifetimes. For example, programs may have to deal with data that has been accumulated over long time periods. The programs (and corresponding data) may have been created at different times, by different teams of people using different names and/or structural forms for data types. This results in an inconsistent development of the data types for large long-lived datasets and for programs manipulating that data.

Computer systems with structured data that is held persistently, such as computer systems with massive non-volatile memories may utilize self-describing structured data to deal with this issue. The types and component types of structured data may be identified through hashes, such as compositional hashes. This hash information may be kept with the data through the use of a type table.

An example method for data type management may include adding a first data to a first data set. The first data set may belong to a plurality of data sets stored in a memory and each data set in the plurality may correspond to a type table defining data types in the corresponding data set. The method may further include determining that a first data type of the first data is not in a first type table corresponding to the first data set and generating an identifier corresponding to the first data type. The identifier may identify uses of the first data type within each data set in the plurality and may be a standardized value that is used by each data set in the plurality. The method may also include inserting the identifier into the first type table.

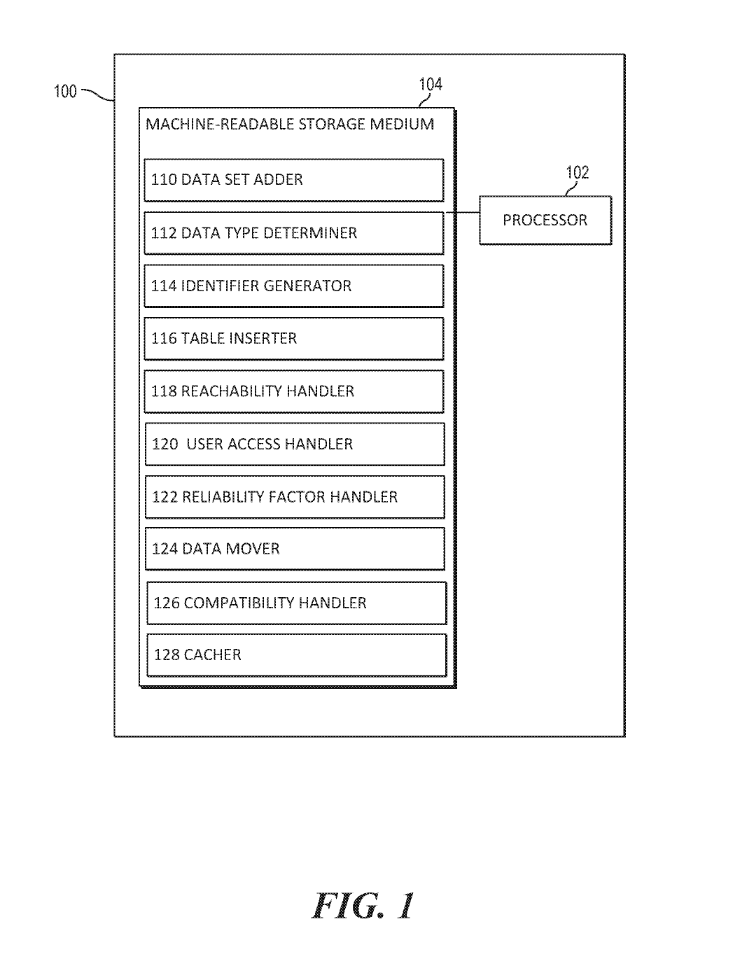

FIG. 1 is a block diagram of an example system 100 for data type management. System 100 may include a processor 102 and a memory 104 that may be coupled to each other through a communication link (e.g., a bus). Processor 102 may include a Central Processing Unit (CPU) or another suitable processor. In some examples, memory 104 stores machine readable instructions executed by processor 102 for operating system 100. Memory 104 may include any suitable combination of volatile and/or non-volatile memory, such as combinations of Random Access Memory (RAM), Read-Only Memory (ROM), flash memory, and/or other suitable memory. Memory 104 may also include a random access non-volatile memory that can retain content when the power is off.

Memory 104 stores instructions to be executed by processor 102 including instructions for a data set adder 110, a data type determiner 112, an identifier generator 114, a table inserter 116, a reachability handler 118, a user access handler 120, a reliability factor handler 122, a data mover 124, a compatibility handler 126, a cacher 128 and/or other components. According to various implementations, data type management system 100 may be implemented in hardware and/or a combination of hardware and programming that configures hardware. Furthermore, in FIG. 1 and other Figures described herein, different numbers of components or entities than depicted may be used.

Processor 102 may execute instructions of data set adder 110 to add a first data to a first data set. A data set, such as the first data set, may comprise a collection of data (including the first data) that may be related through ownership or structure. Adding the first data to the first data set may include creating a record for the first data and/or copying the first data to a memory corresponding to the first data set. The first data set may belong to a plurality of data sets stored in a memory. The memory may be a volatile memory, a non-volatile memory, etc. The memory may also be distributed among a plurality of computer systems. The plurality of computer systems may be part of a cluster of computer systems. Each data set in the plurality of data sets may correspond to a type table.

A type table is data structure that defines data types in the corresponding data set. A data type is a description of a meaning and/or a layout of data. The data type may include a definition of the structure of the data. A data type may be represented by a type constructor and/or by a constructor argument associated with the type constructor. The type constructor of a data type may indicate the kind of the data type, e.g. set, list, record, union, and/or other data type. As another example, a type constructor for a “list” may comprise an array of fields comprising the same data type.

The constructor argument of a data type may indicate a primitive data type or a composite data type that represents the field of the data type. As mentioned above, a data type may be represented by the type constructor and by the arguments where the type is composite. For example, a data type may comprise a type constructor for a “record” that may be associated with a constructor argument indicating a primitive data type and/or a composite data type. An example structural data type may look something like what is shown in Table 1 below.

TABLE 1

| type person = | |
|---|---|
| struct { | |
| name | : String, |
| address | : String, |
| dateOfBirth | : DateTime, |
| gender | : (MALE \| FEMALE) |

}

The example structural data type of table 1 introduces the structural data type person and may be used in programs to give a type to variables such as person: p1, p2, p3.

Data types may comprise a primitive data type or a composite data type. Primitive data types are atomic and may not have any fields. A primitive data type may have specific atomic constituents. Example primitive data types include integers, characters and enumerated types. An example enumerated type that is a primitive data type is a Boolean having certain named values (e.g. TRUE, FALSE etc.). An example primitive data type may look something like what is shown in Table 2 below.

TABLE 2

```
type messageCount =
  struct {
    count : Int
      }
```

The example primitive data type of table 2 one field called “count” whose type is Int. The primitive data type does not have any field.

A composite data type may comprise a data type that comprises at least one field. A structured data type comprising one field may be called a singleton data type. Examples of a composite data type may be union, list, record, and/or other data types that comprise at least one field.

A data type may comprise a type constructor and at least one constructor argument associated with the type constructor. Type constructors may be associated with collection types. Collection types (such as sets, lists, arrays, strings) may possess some way of adding, selecting and indexing entries. For example, List(Int) is a constructed type that may describe a list of integers. In this example, the type constructor is “List” and its single argument is “Int”. Another example constructed type is Set(List(Int)) that may describe a set of lists of integers. In this example, the type constructor is “Set” and the argument type is the structural composite type “List(Int)” denoting a list of integers.

The constructor argument may comprise a first constructor argument and a second constructor argument associated with the type constructor of a data type. The type constructor, the first constructor argument and the second constructor argument may represent the data type. A first predetermined code value may represent the first constructor argument and a second predetermined code value may represent the second constructor argument. The hardware processor may generate an identifier using the type constructor, the first predetermined code value and the second predetermined code value.

Processor 102 may execute instructions of data type determiner 112 to determine whether a first data type of the first data is in a first type table corresponding to the first data set. Each data type may be represented by an identifier. The identifier may comprise a name, and/or other type of identifier. Data type determiner 112 may determine the identifier representing the first data type of the first data and determine if the determined identifier is in the first type table. Data type determiner 112 may determine that the first data type is in the first type table and take no further action. Data type determiner 112 may determine that the first data type is not in the first type table and pass the first data type to identifier generator 114.

Processor 102 may execute instructions of identifier generator 114 to generate an identifier that identifies uses of the first data type within each data set in the plurality. The identifier may correspond to the first data type. The identifier may be consistent between each data set in the plurality. In other words, the identifier may be a standardized value that is used by each data set in the plurality. For example, data types may comprise different type constructors and constructor arguments. Hashing the first data type may result in a first identifier. One type of hashing that may be used is compositional hashing. Compositional hashing is a form of structural hashing that preserves type in-equivalence. In other words, types that aren't equivalent will hash to distinct hashes. For example, the primitive data types Bool and Int have distinct hashes. Identifier generator 114 may generate an identifier corresponding to the first data type using respective type constructors and predetermined code values. A standard set of identifiers may be used by the data sets in the plurality of data sets, such that the identifiers (i.e. a data type code value) remain consistent as the data is transferred, copied, moved, etc. from data set to data set (as will be discussed in further detail below in reference to data mover 124).

Processor 102 may execute instructions of table inserter 116 to insert the identifier into the first type table. The identifier may be linked to the first data type. Table inserter 116 may store the identifier in the type table. Table inserter 116 may arrange the identifiers in the type table so as to obtain a canonical description of data types used.

Processor 102 may execute instructions of reachability handler 118 to determine that a first data type is reachable and mark an identifier corresponding to the first data type as a reachable data type. Reachability handler 118 may further remove an unmarked data type from the first type table. Reachability handler 118 may perform at least one of these actions during garbage collection.

Garbage collection is a process performed by a garbage collector to distinguish between data objects that are reachable and those that are unreachable, where an object is reachable if it is possible for any program code to make reference to the object. When objects are determined to be unreachable, the garbage collector declares the space they occupy to be unallocated and returns the memory to an allocator for use in allocating new objects. An allocator manages unused space in memory and provides memory to programs for creating objects. During garbage collection of a data set, reachable data types (via their identifiers) may be marked as well as reachable data and unused types may be removed from the data set.

Processor 102 may execute instructions of user access handler 120 to determine a first data set is protected from a user and prevent the user from accessing a first type table corresponding to the first data set. In some environments, certain data may be accessible by certain users of a computer system. User access handler 120 may determine the permissions of a first data set in regards to a particular user and prevent the user from accessing the type table corresponding to the first data set. For example, user access handler 120 may make the type table corresponding to the first data set invisible to a user that does not have permission to access the first data set.

Processor 102 may execute instructions of reliability factor handler 122 to store a first type table based on a first reliability factor corresponding to a first data set. Each data set in the plurality of data sets stored in the memory (e.g. as discussed in reference to data set adder 110) may have a reliability factor. The reliability factor may define requirements for storing data from the corresponding data set. For example, data with a high reliability factor may be stored in a certain critical area of memory or stored redundantly in multiple locations on the memory, whereas data with a low reliability factor may be stored in a single location in memory.

When data is copied or moved from one data set to another, a corresponding type table entry may be copied if not present. In this manner, data type management may be based on the type table that is kept with the data, rather than compatibility with the computer system where the data is being transferred. Processor 102 may execute instructions of data mover 124 to move a first data to a second data set. The second data set may belong to a plurality of data sets (e.g. as discussed in reference to data set adder 110). Data mover 124 may determine that a first data type of the first data is not in a second type table corresponding to the second data set and insert an identifier into a second type table (e.g. as discussed in reference to identifier generator 114).

Type-checking structural types may be computationally expensive, especially for larger structural types. As discussed above, type-check expressions can be performed by comparing the type hashes, such as the compositional type hashes, associated with each value. However, types that are related but not identical, such as in sub-type hierarchies, may not be comparable in this way since two types may be compatible but may not be equivalent and thus not have the same hash. Data types that are compatible are interoperable with each other without any alteration. Although two data types may be different, they still may compatible. For example, data types may have super-types, sub-types, etc. As a more specific example, an integer may be considered as a sub-type of a float and a record containing an integer may be considered as a sub-type of a similar record containing a float in the same field. Of course this is only a simple example and the compatibility may be applied to more complex types such as function, record, union, etc.

An identifier (e.g. as discussed in reference to identifier generator 114) may be paired with a relationship label that provides information about relationships without having to inspect the type structures. The relationship label may at least one bit. The information can either be a general indication that such relationships can exist, or can be divided into different type of relationship—such as “may have super-types”, “may have sub-types”, “may have both”, etc. The handle may also include an arity of user-specified type constructors (i.e. type operators). In general, the arity of a function or operation symbol is the number of arguments needed to correctly form an acceptable expression.

The relationship label may indicate a compatibility between a first data type and a second data type. The assembly of the identifier and the relationship label may be referred to as a “handle.” If a first identifier corresponding to a first data of a first data type does not match a second identifier corresponding to a second data of a second data type, a first relationship label corresponding to the first data may be compared to a second relationship label corresponding to the second data.

Processor 102 may execute instructions of compatibility handler 126 to determine a potential compatibility between the first data type and the second data type based on the relationship label. If the compatibility handler 126 determines that the relationship labels of the first data and the second data do not match in the types being compared when they have different hashes, then the comparison may be considered as failed and that the first data and second data are not considered to be compatible.

If the compatibility handler 126 determines that the relationship labels of the first data and the second data match, compatibility handler 126 may perform a detailed comparison of the first and/or second data types (i.e. the first and the second data types). For example, compatibility handler 126 may determine the structure of the data type, such as what types of constructor arguments and/or other parameters are associated with the type constructor of the data type. Compatibility handler 126 may also determine if the data type has any related data types. Processor 102 may execute instructions of cacher 128 to cache a result of the detailed comparison. The result may be cached in the type table. The relationships indicated by the result may be replicated, copied, moved and garbage collected along with the underlying types. A result indicating a relationship and a result indicating the lack of a relationship may be cached.

Well known common relationships between data types may be prepopulated into a type table. For example, certain relationships may be included in a type table by default. An example pre-population is to add an integer variant of any data type that uses a float, and the appropriate relationship (be that sub-type or super-type). Relationships between built in types may also be included in the type table. Built in types are data types that are provided by a programming language.

When a data type is first entered into the table (e.g. as discussed in reference to table inserter 116), then some types in relationship to that type, and those relationships, could also be populated into the table. The relationship insertion may be done at the time of inserting the type into the table or in the background. Some data type models may encode multiple inheritance, and prepopulating relationships may be impractical. In an aspect, only a subset of the common relationships may be prepopulated.

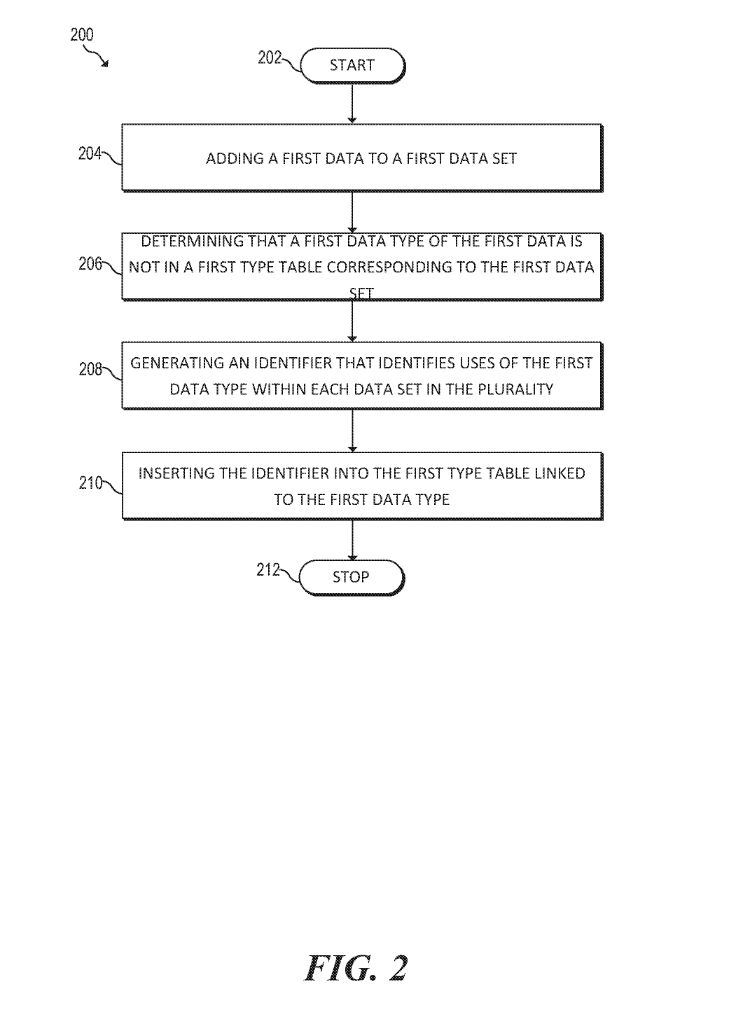

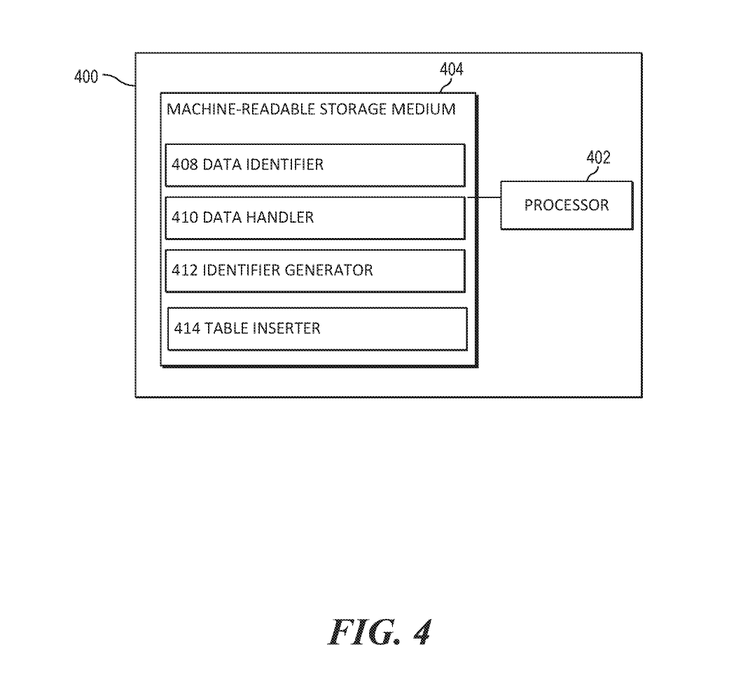

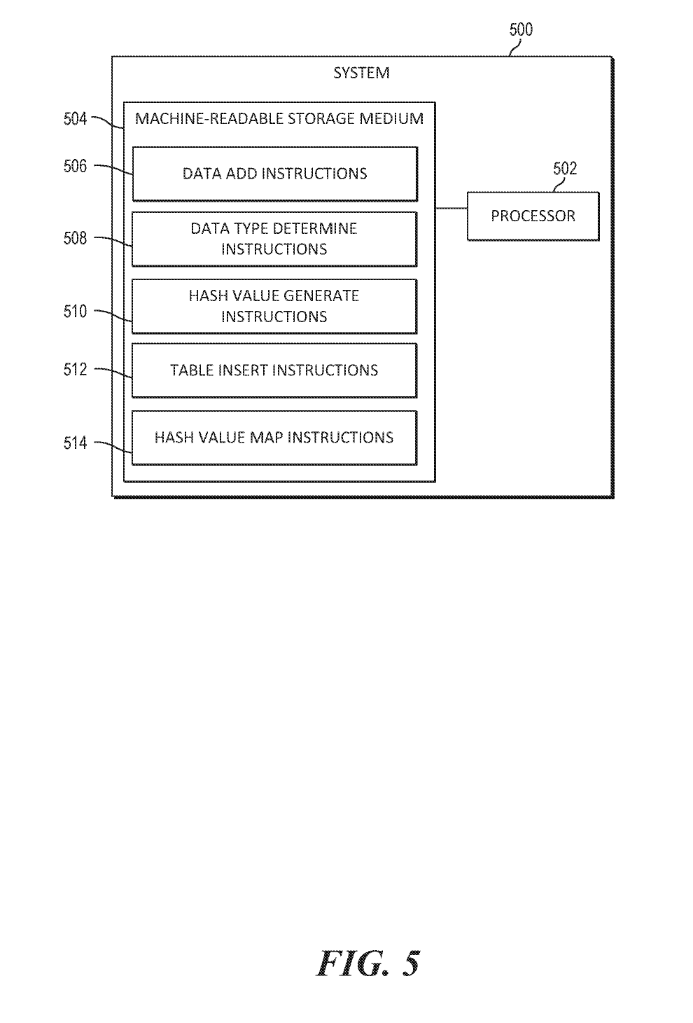

FIG. 2 is a flowchart of an example method 200 for data type management. Method 200 may be described below as being executed or performed by a system, for example, system 100 of FIG. 1, system 400 of FIG. 4 or system 500 of FIG. 5. Other suitable systems and/or computing devices may be used as well. Method 200 may be implemented in the form of executable instructions stored on at least one machine-readable storage medium of the system and executed by at least one processor of the system. The machine-readable storage medium may be non-transitory. Method 200 may be implemented in the form of electronic circuitry (e.g., hardware). At least one block of method 200 may be executed substantially concurrently or in a different order than shown in FIG. 2. Method 200 may include more or less blocks than are shown in FIG. 2. Some of the blocks of method 200 may, at certain times, be ongoing and/or may repeat.

Method 200 may start at block 202 and continue to block 204, where the method may include adding a first data to a first data set. The first data set may belong to a plurality of data sets stored in a memory. The memory may be a non-volatile memory. The memory may be distributed among a plurality of computer systems. Each data set in the plurality may correspond to a type table defining data types in the corresponding data set. At block 206, the method may include determining that a first data type of the first data is not in a first type table corresponding to the first data set. At block 208, the method may include generating an identifier that identifies uses of the first data type within each data set in the plurality. The identifier may correspond to the first data type. The identifier may be a standardized value that is used by each data set in the plurality. The identifier may be consistent between each data set in the plurality. The identifier may also include a hash value and the first type table may include a mapping between the hash value and the first data type. The identifier may include a relationship label indicating a compatibility between the first data type and a second data type. At block 210, the method may include inserting the identifier into the first type table linked to the first data type. Method 200 may eventually continue to block 212, where method 200 may stop.

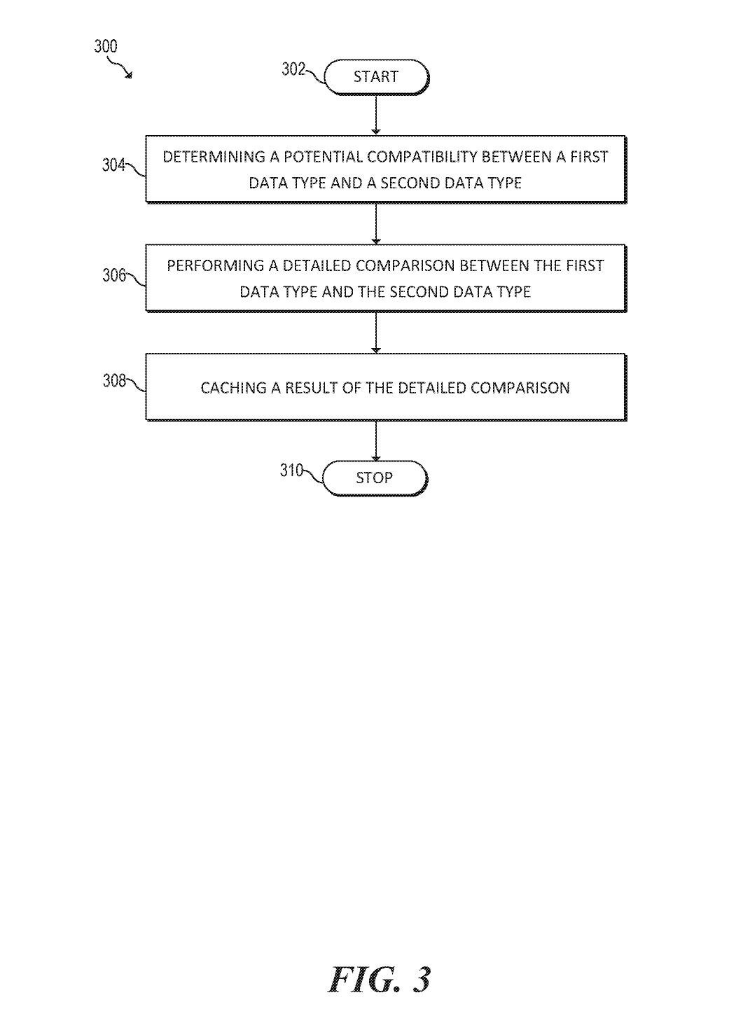

FIG. 3 is a flowchart of an example method 300 for determining compatibility between data types. Method 300 may be described below as being executed or performed by a system, for example, system 100 of FIG. 1, system 400 of FIG. 4 or system 500 of FIG. 5. Other suitable systems and/or computing devices may be used as well. Method 300 may be implemented in the form of executable instructions stored on at least one machine-readable storage medium of the system and executed by at least one processor of the system. The machine-readable storage medium may be non-transitory. Method 300 may be implemented in the form of electronic circuitry (e.g., hardware). At least one block of method 300 may be executed substantially concurrently or in a different order than shown in FIG. 3. Method 300 may include more or less blocks than are shown in FIG. 3. Some of the blocks of method 300 may, at certain times, be ongoing and/or may repeat.

Method 300 may start at block 302 and continue to block 304, where the method may include determining a potential compatibility between a first data type and a second data type. The determination may be made based on a relationship label. The relationship label may indicate a compatibility between a first data type and a second data type. At block 306, the method may include performing a detailed comparison between the first data type and the second data type. The detailed comparison may include an analysis of the structure of the first and second data type to determine if the first and second data types are compatible. At block 308, the method may include caching a result of the detailed comparison. The result may be cached and/or otherwise stored with a type table. Method 300 may eventually continue to block 310, where method 300 may stop.

FIG. 4 is a block diagram of an example system 400 for data type management. System 400 may include a processor 402 and a memory 404 that may be coupled to each other through a communication link (e.g., a bus). Processor 402 may include a Central Processing Unit (CPU) or another suitable processor. In some examples, memory 404 stores machine readable instructions executed by processor 402 for operating system 400. Memory 404 may include any suitable combination of volatile and/or non-volatile memory, such as combinations of Random Access Memory (RAM), Read-Only Memory (ROM), flash memory, and/or other suitable memory.

Memory 404 stores instructions to be executed by processor 402 including instructions for a data identifier 408, a data handler 410, an identifier generator 412 and table inserter 414. The components of system 400 may be implemented in the form of executable instructions stored on at least one machine-readable storage medium of system 400 and executed by at least one processor of system 400. The machine-readable storage medium may be non-transitory. Each of the components of system 400 may be implemented in the form of at least one hardware device including electronic circuitry for implementing the functionality of the component.

Processor 402 may execute instructions of data identifier 408 to identify a plurality of data sets stored on a memory. Each data set in the plurality may include a type table defining data types in the corresponding data set. The memory may be a non-volatile memory. The memory may be distributed among a plurality of computer systems. Processor 402 may execute instructions of data handler 410 to determine that a first data in a first data set belongs to the plurality. The first data may be of a first data type. Processor 402 may execute instructions of identifier generator 412 to generate an identifier that identifies uses of the first data type within each data set in the plurality. The identifier may correspond to the first data type. The identifier may be a standardized value that is used by each data set in the plurality. The identifier may be consistent between each data set in the plurality. The identifier may also include a hash value. The identifier may include a relationship label indicating a compatibility between the first data type and a second data type. Processor 402 may execute instructions of table inserter 414 to insert the identifier into a first type table corresponding to the first data set. The identifier may be linked to the first data type.

FIG. 5 is a block diagram of an example system 500 for data type management. System 500 may be similar to system 100 of FIG. 1, for example. In the example illustrated in FIG. 5, system 500 includes a processor 502 and a machine-readable storage medium 504. Although the following descriptions refer to a single processor and a single machine-readable storage medium, the descriptions may also apply to a system with multiple processors and multiple machine-readable storage mediums. In such examples, the instructions may be distributed (e.g., stored) across multiple machine-readable storage mediums and the instructions may be distributed (e.g., executed by) across multiple processors.

Processor 502 may be at least one central processing unit (CPU), microprocessor, and/or other hardware devices suitable for retrieval and execution of instructions stored in machine-readable storage medium 504. In the example illustrated in FIG. 5, processor 502 may fetch, decode, and execute instructions 506, 508, 510, 512 and 514 to perform data type management. Processor 502 may include at least one electronic circuit comprising a number of electronic components for performing the functionality of at least one of the instructions in machine-readable storage medium 504. With respect to the executable instruction representations (e.g., boxes) described and shown herein, it should be understood that part or all of the executable instructions and/or electronic circuits included within one box may be included in a different box shown in the figures or in a different box not shown.

Machine-readable storage medium 504 may be any electronic, magnetic, optical, or other physical storage device that stores executable instructions. Thus, machine-readable storage medium 504 may be, for example, Random Access Memory (RAM), an Electrically-Erasable Programmable Read-Only Memory (EEPROM), a storage drive, an optical disc, and the like. Machine-readable storage medium 504 may be disposed within system 500, as shown in FIG. 5. In this situation, the executable instructions may be “installed” on the system 500. Machine-readable storage medium 504 may be a portable, external or remote storage medium, for example, that allows system 500 to download the instructions from the portable/external/remote storage medium. In this situation, the executable instructions may be part of an “installation package”. As described herein, machine-readable storage medium 504 may be encoded with executable instructions for test session similarity determination. The machine-readable storage medium may be non-transitory.

Referring to FIG. 5, data add instructions 506, when executed by a processor (e.g., 502), may cause system 500 to add a first data to a first data set. The first data set may belong to a plurality of data sets stored in a memory. The memory may be a non-volatile memory. The memory may be distributed among a plurality of computer systems. Each data set in the plurality may correspond to a type table defining data types in the corresponding data set. Data type determine instructions 508, when executed by a processor (e.g., 502), may cause system 500 to determine that a first data type of the first data is not in a first type table corresponding to the first data set. Hash value generate instructions 510, when executed by a processor (e.g., 502), may cause system 500 to generate a hash value that identifies uses of the first data type within each data set in the plurality. The hash value may correspond to the first data type. The hash value may be consistent between each data set in the plurality. The hash value may be a standardized value that is used by each data set in the plurality. The hash value may be paired with a relationship label indicating a compatibility between the first data type and a second data type. Table insert instructions 512, when executed by a processor (e.g., 502), may cause system 500 to insert the hash value into the first type table. Hash value map instructions 514, when executed by a processor (e.g., 502), may cause system 500 to map the hash value to the first data type in the first type table.

The foregoing disclosure describes a number of examples for data type management. The disclosed examples may include systems, devices, computer-readable storage media, and methods for data type management. For purposes of explanation, certain examples are described with reference to the components illustrated in FIGS. 1-5. The functionality of the illustrated components may overlap, however, and may be present in a fewer or greater number of elements and components. Further, all or part of the functionality of illustrated elements may co-exist or be distributed among several geographically dispersed locations. Further, the disclosed examples may be implemented in various environments and are not limited to the illustrated examples.

Further, the sequence of operations described in connection with FIGS. 1-5 are examples and are not intended to be limiting. Additional or fewer operations or combinations of operations may be used or may vary without departing from the scope of the disclosed examples. Furthermore, implementations consistent with the disclosed examples need not perform the sequence of operations in any particular order. Thus, the present disclosure merely sets forth possible examples of implementations, and many variations and modifications may be made to the described examples.

1) A method comprising:
adding a first data to a first data set, wherein the first data set belongs to a plurality of data sets stored in a memory and each data set in the plurality corresponds to a type table defining data types in the corresponding data set;
determining that a first data type of the first data is not in a first type table corresponding to the first data set;
generating an identifier that identifies uses of the first data type within each data set in the plurality wherein the identifier is a standardized value that is used by each data set in the plurality; and
inserting the identifier into the first type table linked to the first data type.

2) The method of claim 1 further comprising:
determining that the first data is reachable;
marking the identifier corresponding to the first data type as a reachable data type; and
removing, during garbage collection, an unmarked data type from the first type table.

3) The method of claim 1 further comprising:
determining that the first data set is protected from a user; and
preventing the user from accessing the first type table corresponding to the first data set.

4) The method of claim 1 wherein each data set in the plurality has a reliability factor, the method further comprising:
storing the first type table based on a first reliability factor corresponding to the first data set.

5) The method of claim 1 further comprising:
moving the first data to a second data set, wherein the second data set belongs to the plurality;
determining that the first data type of the first data is not in a second type table corresponding to the second data set; and
inserting the identifier into the second type table.

6) The method of claim 1 wherein the memory is distributed among a plurality of computer systems.

7) The method of claim 1 wherein the identifier includes a hash value and the first type table includes a mapping between the hash value and the first data type.

8) The method of claim 7 wherein the identifier includes a relationship label indicating a compatibility between the first data type and a second data type.

9) The method of claim 8 further comprising:
determining a potential compatibility between the first data type and the second data type based on the relationship label; and
performing a detailed comparison between the first data type and the second data type.

10) The method of claim 9 further comprising:
caching a result of the detailed comparison.

11) A system comprising:
a data identifier to identify a plurality of data sets stored on a memory, wherein each data set in the plurality includes a type table defining data types in the corresponding data set;
a data handler to determine that a first data in a first data set belongs to the plurality, wherein the first data is of a first data type;
an identifier generator to generate that identifies uses of the first data type within each data set in the plurality wherein the identifier is a standardized value that is used by each data set in the plurality; and
a table inserter to insert the identifier into a first type table corresponding to the first data set linked to the first data type.

12) The system of claim 11 further comprising:
a compatibility determiner to determine a potential compatibility between the first data type and a second data type;
a comparison performer to perform a detailed comparison between the first data type and the second data type; and
a cacher to cache a result of the detailed comparison.

13) The system of claim 11 further comprising:
a data mover to move the first data to a second data set, wherein the second data set belongs to the plurality;
a type determiner to determine that the first data type of the first data is not in a second type table corresponding to the second data set; and
the table inserter further to insert the identifier into the second type table.

14) A non-transitory machine-readable storage medium encoded with instructions, the instructions executable by a processor of a system to cause the system to:
add a first data to a first data set, wherein the first data set belongs to a plurality of data sets stored in a memory and each data set in the plurality corresponds to a type table defining data types in the corresponding data set;
determine that a first data type of the first data is not in a first type table corresponding to the first data set;
generate a hash value that identifies uses of the first data type within each data set in the plurality wherein the hash value is a standardized value that is used by each data set in the plurality;
insert the hash value into the first type table; and
map the hash value to the first data type in the second type table.

15. The non-transitory machine-readable storage medium of claim 14, wherein the instructions executable by the processor of the system further cause the system to:
create a handle corresponding to the first data type, wherein the handle includes the hash value and a relationship label indicating a compatibility between the first data type and a second data type
determine a potential compatibility between the first data type and a second data type based on the relationship label;
perform a detailed comparison between the first data type and the second data type; and
cache a result of the detailed comparison in the first type table.
